(19) United States
(12) Patent Application Publication
(10) Pub. No.: US 2016/0067965 A1
(43) Pub. Date: Mar. 10, 2016

(54) IMPRINTING METHOD AND IMPRINTING APPARATUS

(71) Applicant: KABUSHIKI KAISHA TOSHIBA, Tokyo (JP)

(72) Inventors: Shizuo KINOSHITA, Yokohama (JP); Yohko KOMATSU, Kawasaki (JP)

(21) Appl. No.: 14/637,731

(22) Filed: Mar. 4, 2015

(30) Foreign Application Priority Data
Sep. 8, 2014 (JP) 2014-182196

(51) Int. Cl. B41J 2/045

(52) U.S. Cl. CPC B41J 2/04593; B41J 2/04586

(57) ABSTRACT

According to one embodiment, an imprinting method is provided to form a pattern by ejecting an imprint agent onto a workpiece from a plurality of nozzles of an ink-jet head according to a drop recipe, and putting a template and the workplace having the imprinted agent ejected thereon closer to have a predetermined distance therebetween. In the imprinting method, a first drop recipe is generated at first. Next, a drop position in the first drop recipe is changed to another position in the vicinity of the drop position.

### CROSS-REFERENCE TO RELATED APPLICATIONS

This application is based. upon and claims the benefit of priority from Japanese Patent Application No, 2014-182196, filed on Sep. 8, 2014; the entire contents of which are incorporated herein by reference,

### FIELD

Embodiments described herein relate generally to an imprinting method and an imprinting apparatus,

### BACKGROUND

In imprinting methods, an imprint agent is dropped on a workpiece, a template is pressed on the workpiece, the imprint agent is cured, and a mask pattern is formed thereon. An ink-jet head may be used to drop the imprint agent. The inkjet head has a configuration in which nozzles configured to eject the imprint agent are disposed in line. The ink-jet head is made to scan at predetermined intervals, in a direction perpendicular to a nozzle arrangement direction, and the imprint agent is ejected from a predetermined nozzle.

Conventionally, the ink-jet head has been used as a component member of a printer. However, the printer cannot change data to be printed. Therefore, methods for compensating a non-ejecting nozzle have been proposed by which, for example, the number of times of scanning is increased to prevent deterioration in quality of a printed image, when the ink-jet head has the non-ejecting nozzle

Even the ink-jet head used for the imprinting method may have a non-ejecting nozzle. Due to the problem of throughput degradation or the like, it is not preferable that the conventional method for compensating a non-ejecting nozzle for the ink-jet head of the printer is directly applied to the non-ejecting nozzle used for the imprinting method. Therefore, a measure against generation of the non-ejecting nozzle of the ink-jet head in the imprinting method has been required.

### BRIEF DESCRIPTION OF THE DRAWINGS

FIG. 1 is a schematic cross-sectional view illustrating an exemplary configuration of an imprinting apparatus according to a first embodiment;

FIG. 2 is an exemplary schematic diagram illustrating a bottom surface of an ink-jet head;

FIG. 3 is a block diagram illustrating a functional configuration of a control processor according to the first embodiment;

FIG. 4 is an exemplary diagram illustrating a drop recipe;

FIG. 5 is an exemplary flowchart illustrating a procedure of a drop recipe generation process according to the first embodiment;

FIG. 6 is an exemplary flowchart illustrating a procedure of a drop relocation process for a non-ejecting nozzle according to the first embodiment;

FIG. 7 is a diagram illustrating a specific example of a drop recipe changing process;

FIG. 8 is an exemplary block diagram illustrating a functional configuration of a control processor according to a second embodiment;

FIG. 9 is an exemplary flowchart illustrating a procedure of a drop recipe generation process according to the second embodiment;

FIG. 10 is an exemplary block diagram illustrating a functional configuration of a control processor according to a third embodiment; and

FIG. 11 is an exemplary flowchart illustrating a procedure of a drop recipe generation process according to the third embodiment.

### DETAILED DESCRIPTION

In general, according to one embodiment, an imprinting method is provided in which an imprint. agent is ejected onto a workpiece from a plurality of nozzles of an ink-jet head according to a drop recipe, and the workpiece having the imprint agent ejected thereon and a template are put closer to have a predetermined distance to form a pattern. In the imprinting method, first, a first drop recipe is generated. Next, a drop position in the first drop recipe is changed to another position in the vicinity of the drop position.

A non-ejecting nozzle generated in an ink-jet head used for an imprinting method according to embodiments will be described below in detail with reference to accompanying drawings. It is noted that the present invention is not intended to be limited to the embodiments. Additionally, the following embodiments employ a schematic cross-sectional view of an imprinting apparatus, and a relationship between a thickness and a width of each member, a ratio of thicknesses between the members, or the like may be different from those of real members.

### First Embodiment

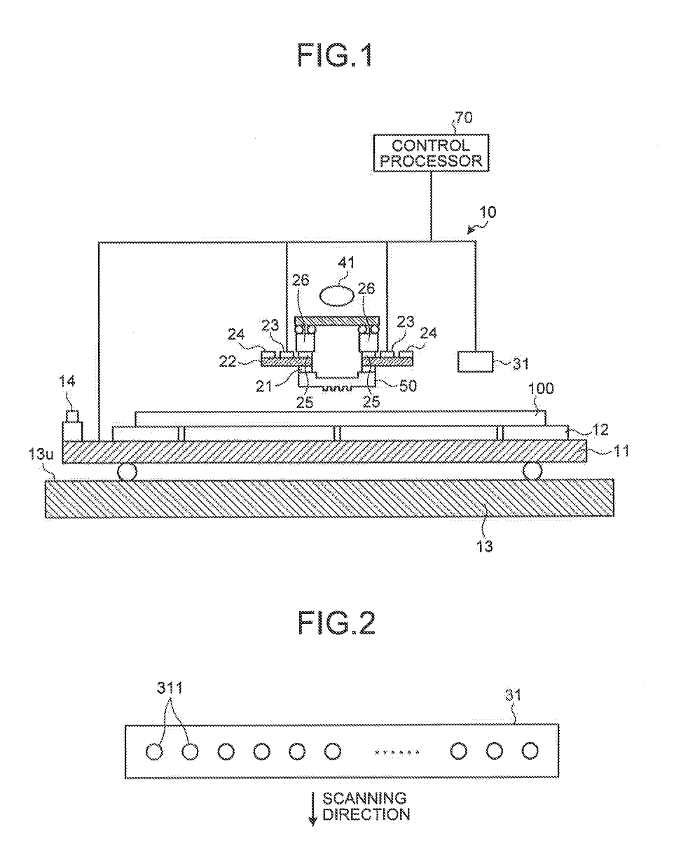

FIG. 1 is a schematic cross-sectional view illustrating an exemplary configuration of an imprinting apparatus according to a first embodiment, and FIG. 2 is an exemplary schematic diagram illustrating a bottom surface of an ink-jet head. The imprinting apparatus includes an imprinting unit 10, and a control processor 70 configured to control the operation of the imprinting apparatus as a whole.

The imprinting unit 10 includes a substrate stage 11 as a workpiece holder. The substrate stage 11 is provided with a vacuum chuck mechanism 12 thereon. The vacuum chuck mechanism 12 holds a substrate 100 as a workpiece. The substrate 100 includes a substrate such as a semiconductor substrate, an underlying pattern formed on the substrate 100, and a layer to be processed formed on the underlying pattern. The substrate further includes an imprint agent (resist) formed on the layer to be processed, when a pattern is transferred. The layer to be processed includes an insulating film, a metal film (conductive film), or a semiconductor film.

The substrate stage 11 is movably provided on a stage surface plate 13. The substrate stage 11 is provided movably in directions of two axes along an upper surface 13u of the stage surface plate 13. Here, the two axes along the upper surface 13u of the stage surface plate 13 are defined as X axis and Y axis. Further, the substrate stage 11 is also provided movably in a direction of Z axis perpendicular to the X axis and the Y axis. Preferably, the substrate stage 11 is provided rotatably around the X axis, Y axis, and Z axis.

The substrate stage 11 is provided with a fiducial mark table 14. A fiducial mark not illustrated is mounted on the fiducial mark table 14. The fiducial mark serves as a reference position of the apparatus. The fiducial mark is used for calibration of an alignment sensor 26 and positioning (control or adjustment of an attitude.) of a template 50. The fiducial mark is an origin on the substrate stage 11. X and Y coordinates of the substrate mounted on the substrate stage 11 are represented as coordinates relative to the origin at the fiducial mark table 14.

The imprinting unit 10 includes a template stage 21 as a template holder. The template stage 21 holds the peripheral edge of the template 50, for example, by vacuum suction to secure the template 50. Here, the template 50 is made of an ultraviolet transmitting material, such as quartz or fluorite. A transferred pattern of concavo-convex shape formed on the template 50 includes a pattern corresponding to a device pattern and a pattern corresponding to an alignment mark used for aligning the template 50 and the substrate 100. The template stage 21 is operated to position the template 50 to the reference position of the apparatus. The template stage 21 is mounted to a base portion 22.

The base portion 22 is mounted with a correction mechanism 23 and a pressurizing unit 24. The correction mechanism 23 includes an adjustment mechanism for finely adjusting the position (attitude) of the template 50, for example, by receiving an instruction from the control processor 70. The correction mechanism 23 finely adjusts the position (attitude) of the template 50, and corrects the position of the template 50 relative to the substrate 100. When a template pattern of the template 50 is pressed into the resist above the substrate 100, the pressurizing unit 24 presses the vicinity of the template 50.

The base portion 22 is mounted to an alignment stage 25. When the template 50 is aligned to the substrate 100, the alignment stage 25 can move the base portion 22 in X and Y axes directions. Further, the alignment stage 25 also includes a function for rotating the base portion 22 along XY plane.

The alignment stage 25 is provided with an alignment sensor 26. The alignment sensor 26 detects positional deviation of the template 50 relative to the fiducial mark on the fiducial mark table 14, and positional deviation of the substrate 100 relative to the template 50. A detection result is transmitted to the control processor 70. In FIG. 1, two alignment sensors 26 disposed on the right and left sides are illustrated, but it is preferable that four or more alignment sensors are disposed.

For the detection of the positional deviation of the template 50 relative to the fiducial mark, the fiducial mark, not illustrated, and the alignment mark, not illustrated, provided at the template 50 are used. The fiducial mark and the alignment mark of the template 50 are composed of a diffraction grating, for example. The alignment sensor 26 detects light radiated to and diffracted and reflected from the fiducial mark and the alignment mark of the template 50.

For the detection of the positional deviation of the substrate 100 relative to the template 50, the alignment mark, not illustrated, provided at the template 50 and an alignment mark, not illustrated, provided at the substrate 100 are used. These alignment marks are composed of a diffraction grating, for example. The alignment sensor 2 detects light radiated to and diffracted and reflected from these alignment marks.

The imprinting unit 10 includes an ink-jet head 31 at a position facing the substrate stage 11. The ink-jet head 31 drops the imprint agent including a resin on the substrate 100, As illustrated in FIG. 2, the ink-jet head 31 includes a plurality of nozzles 311 on a bottom surface, and the imprint agent is dropped from the nozzles 311 onto the substrate 100. The plurality of nozzles 311 are arranged in line. The nozzles are arranged in a direction perpendicular to a scanning direction of the ink-jet head 31. As the imprint agent, for example, an ultraviolet curable resin can be used.

The imprinting unit 10 includes a light source 41 configured to emit light (e.g., ultraviolet light) for curing the imprint agent while the template 50 is pressed on the substrate 100 through the imprint agent. The light source 41 may be mounted immediately above the template 50, or may be mounted at a position other than the position immediately above the template 50 so that light is radiated to the position immediately above the template 50 using an optical member such as a mirror.

The control processor 70 controls an imprinting process in the imprinting apparatus. For example, the positional deviation of the template 50 relative to the fiducial mark on the fiducial mark table 14, and the positional deviation of the substrate 100 relative to the template 50, are calculated based on information front the alignment sensor 25. Based on the positional deviation, an instruction for alignment between the fiducial mark table 14 and the template 50, and an instruction for alignment between the template 50 and the substrate 100 are transmitted to the alignment stage 25 and the substrate stage 11 of imprinting unit 10.

The control processor 70 causes the ink-jet head 31 to drop the imprint agent onto the substrate 100 based on a drop recipe. Further the control processor 70 presses the template 50 on the substrate 100 on which the imprint agent has been dropped. In the above-mentioned description, the substrate stage 11 moved relative to the template 50 so that the substrate 100 on the substrate stage 11 and the template 50 have a predetermined distance therebetween has been described. However, the substrate stage 11 may be fixed and the template 50 may be moved, or both of the substrate stage 11 and the template 50 may be moved.

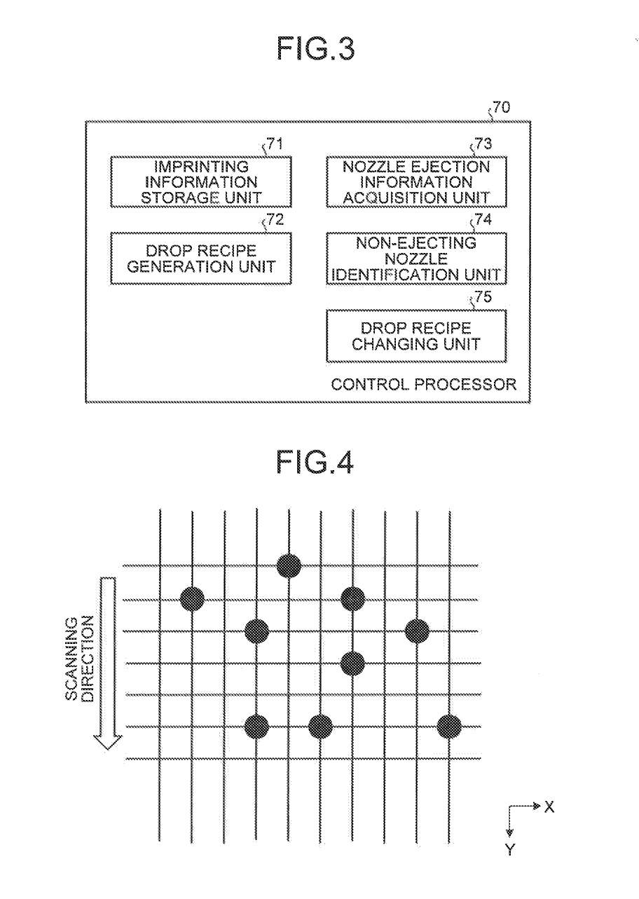

In the first embodiment, the control processor 70 also has a function of generating and changing the drop recipe. The function of generating and changing the drop recipe will be described below. FIG. 3 is a block diagram illustrating a functional configuration of the control processor according to the first embodiment. The control processor 70 includes an imprinting information storage unit 71, a drop recipe generation unit 72, a nozzle ejection information acquisition unit 73, a non-ejecting nozzle identification unit 74, and a drop recipe changing unit 75.

The imprinting information storage unit 71 stores imprinting information required for generating the drop recipe. The imprinting information includes template information, residual layer thickness (RLT), and nozzle resolution. The template information represents information about the pattern formed on the template. The template information represents information, for example, about a density of the pattern. The RLT represents a distance between an upper surface of the substrate 100 and a bottom surface of the template 50 during the imprinting process. Here, the RLT is defined to have one value set to one substrate 100. The nozzle resolution represents a pitch between the nozzles 311 of the ink-jet heed 31.

The drop recipe generation unit 72 generates the drop recipe based on the imprinting information in the imprinting information storage unit 71, using a predetermined algorithm. The algorithm is used to calculate ejection/non-ejection from the nozzle 311 at each position of the ink-jet head 31 so that the RLT has a target value during the imprinting process. For example, when there are a first region having a large number of engraved patterns per unit area and a second region having a small number of engraved patterns per unit area, the algorithm performs calculation so that the first region has a larger amount of drops relative to the second region. At that time, the drop recipe is generated on condition that ejection can be performed through all the nozzles 311 of the ink-jet head. 31. The drop recipe represents image information formed above the substrate 100 with the imprint agent, and includes drop location, relationship between the nozzles to be used and drops, or the like. The drop recipe generation unit 72 is implemented in software.

FIG. 4 is an exemplary diagram illustrating the drop recipe. In the figure, an X direction represents the arrangement direction of the nozzles 311 of the ink-jet head 31, and a Y direction represents the scanning direction of the ink-jet head 31. The X direction and the Y direction are perpendicular to each other. The drop recipe indicates the drop positions of the imprint agent in one shot area.

In the figure, lines perpendicular to the X axis correspond to trajectories of the nozzles 311 upon scanning. Further, lines perpendicular to the Y axis represents positions of the ink-jet head 31 above the substrate 100 at each time during scanning. A virtual grid for dropping position is formed by the lines in the X direction and the lines in the Y direction. An intersection of the line in the X direction and the line in the Y direction is hereinafter referred to as a virtual grid point. The virtual grid points serve as positions to which drops can be placed. In the drop recipe of FIG. 4, the drop locations selected from the virtual grid points are represented by black circles. The drop locations are calculated by the drop recipe generation unit 72.

The nozzle ejection information acquisition unit 73 causes the ink-jet head 31 to perform a test to check states of the nozzles 311, and acquires resultant nozzle ejection information. For example, in order to confirm ejection states of the nozzles 311, on the imprinting unit 10, the nozzle ejection information acquisition unit 73 causes each nozzle 311 to eject the imprint agent (cured resin), and acquires an image showing the placement of imprint agent droplets. The image showing the placement of the imprint agent droplets corresponds to nozzle ejection information. The nozzle ejection information acquisition unit 73 is implemented in software.

The non-ejecting nozzle identification unit 74 identifies the non-ejecting nozzle based on the nozzle ejection information. For example, from the image showing the placement of imprint agent droplets, having been acquired by the nozzle ejection information acquisition unit 73, a part without placement of the imprint agent droplet is acquired, and a position of the non-ejecting nozzle is identified. It is noted that the non ejecting nozzle may include a nozzle only ejecting the imprint agent in an amount equal to or less than a predetermined amount in addition to a nozzle not ejecting the imprint agent. The non-ejecting nozzle identification unit 74 is implemented in software.

When the non-ejecting nozzle is found by the non-ejecting nozzle identification unit 74, the drop recipe changing unit 75 does not generate a new drop recipe, but changes the drop recipe so that a drop (imprint agent) supposed to be ejected from the non-ejecting nozzle is relocated to be compensated. Specifically, a virtual grid point is defined as a compensation position. The virtual grid point is near the drop position corresponding to the non-ejecting nozzle (a first nozzle), and does not have a drop position of the imprint, agent corresponding to another nozzle 311 (a second nozzle) around the virtual grid point. The drop recipe changing unit 75 is implemented in software.

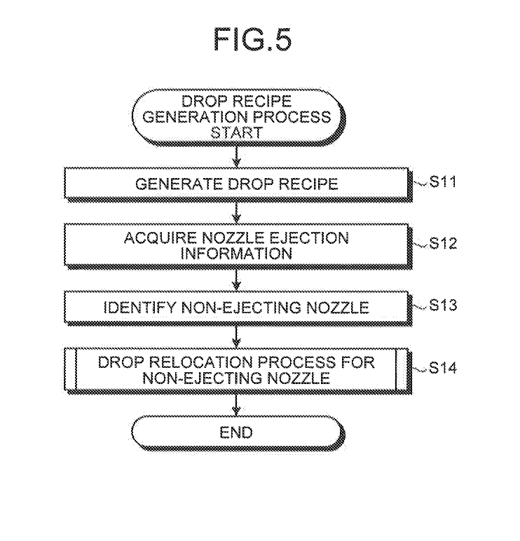

Next, description will be made of drop recipe generation process in the imprinting apparatus having such a configuration. FIG. 5 is an exemplary flowchart illustrating a procedure of a drop recipe generation process according to the first embodiment.

First, the drop recipe generation unit 72 generates the drop recipe representing an imprint agent drop position in the shot area, based on the template information, the RLT, and the nozzle resolution in the imprinting information storage unit 71 (step S11). The drop recipe is generated on condition that all the nozzles 311 of the ink-jet head 31 are allowed to eject the imprint agent. Further, the drop recipe is optimized as a whole so that a variation in RLT falls within a predetermined range relative to the target value, over the whole shot area.

Next, the nozzle ejection information acquisition unit 73 performs the test on the ink-jet head 31 mounted to the imprinting apparatus for ejection of the imprint agent, and acquires the nozzle ejection information (step S12). After that, the non-ejecting nozzle identification unit 74 identifies the non-ejecting nozzle based on the nozzle ejection information (step S13).

The drop recipe changing unit 75 performs a relocation process for relocating the drop supposed to be ejected from the non-ejecting nozzle (step S14), and the process is finished. It is noted that, when the non-ejecting nozzle is riot found, the relocation process of step S14 is not performed.

It is noted that the process illustrated in FIG. 5 is performed, when the imprinting apparatus is started, when the ink-jet head 31 is mounted, or when determination is made of the suspected non-ejecting nozzle by the imprinting process.

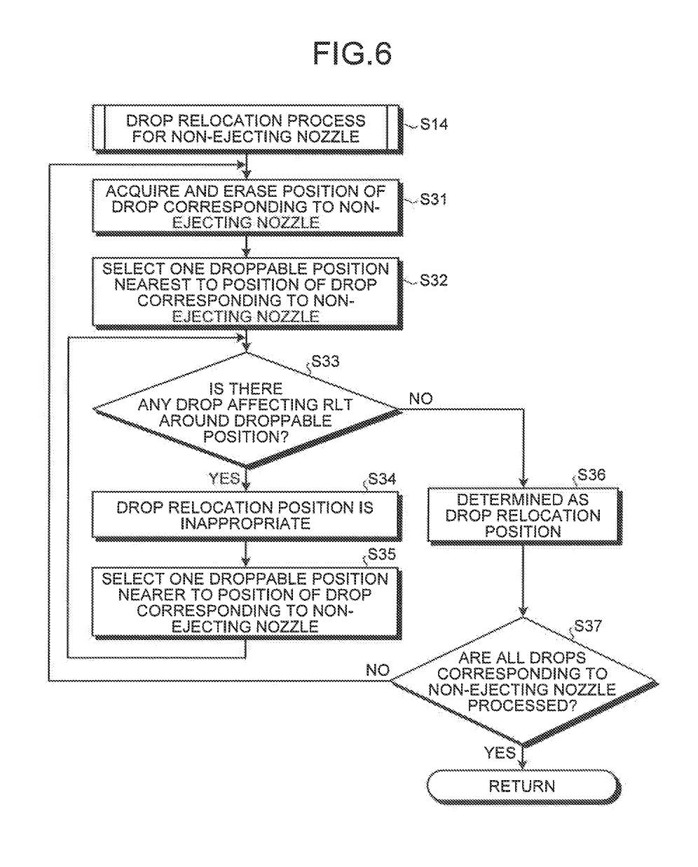

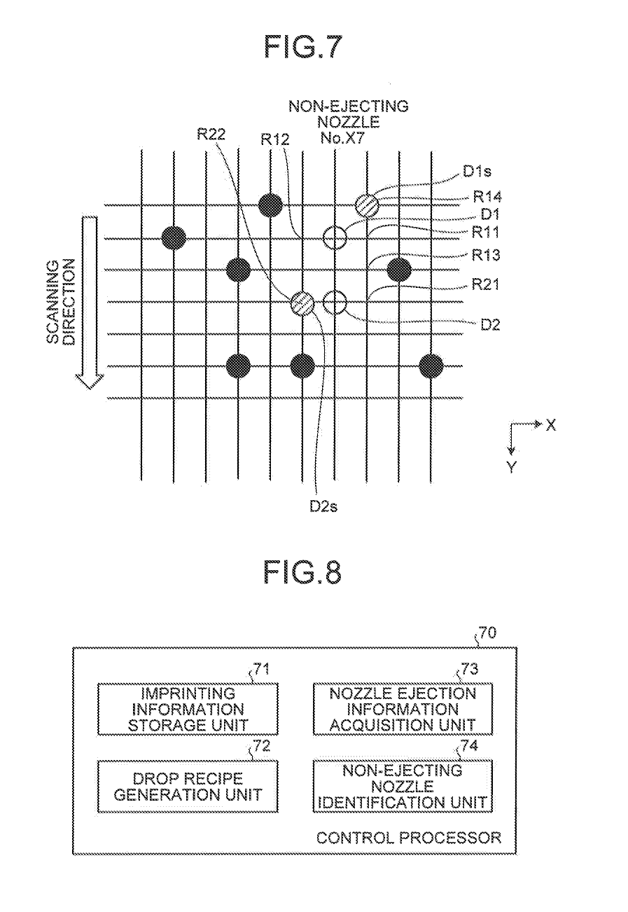

Here, a drop relocation process of step S14 will be described in detail. FIG. 6 is an exemplary flowchart illustrating a procedure of the drop relocation process for the non-ejecting nozzle according to the first embodiment. FIG. 7 is a diagram illustrating a specific example of a drop recipe changing process.

First, the drop recipe changing unit 75 acquires, in the drop recipe, a drop position (a first drop position) corresponding to the non-ejecting nozzle, and erases the drop position (step S31). In an example of FIG. 7, the non-ejecting nozzle is a nozzle “No. X7”. Accordingly, a drop is to be relocated which is on a position corresponding to the non-ejecting nozzle “No. X7” where the imprint agent is to be dropped. In this example, drops D1 and D2 are to be relocated.

Next, one droppable position is selected. The droppable position is the virtual grid point nearest to the position of the drop corresponding to the non-ejecting nozzle (step S32). For example, when the drop D1 is relocated, positions R11 and R12 nearest to the drop D1 are employed as the droppable position, and, for example, the position R11 is selected therefrom.

After that, it is determined whether the selected droppable position has therearound a drop affecting the RLT (step S33). For example, the selected position R11 has eight virtual grid points therearound. Five are selected from the eight virtual grid points excluding the virtual grid points corresponding to the positions of the non ejecting nozzle. When a drop is located at any of the five virtual grid points, the drop is determined to affect the RLT. In the above-mentioned example, the position R11 has therearound the drop affecting the RLT.

When the droppable position has therearound the drop affecting the RLT (step S33, Yes), the drop recipe changing unit 75 determines that the droppable position selected in step S32 is inappropriate as a relocation position (step S34). Next, another droppable position is selected which is nearest or next nearest to the drop position corresponding to the non-ejecting nozzle (step S35). After that the process returns to step S33. The selected another droppable position is processed similarly.

In the above-mentioned example, the position R11 is considered inappropriate as a drop relocation position. Next, the position R12 is selected as the droppable position, and is processed similarly as described in steps S33 to S34. The position R12 is also considered inappropriate as the drop relocation position. After that, a position R13 is selected as the droppable position, but the position R13 is also considered inappropriate as the drop relocation position. Further, a position R14 is selected as the droppable position.

When the droppable position does not have therearound the drop affecting the RLT in step S33 (step S33, No), the drop recipe changing unit 75 determines the droppable position selected in step S32 or step S35, as the drop relocation. position (step S36). In the above-mentioned example, the position R14 does not have therearound the drop affecting the RLT. Therefore, the position R14 is determined to be the drop relocation position (a second drop position). Instead of the drop D1, a drop D1s is located to the position R14.

After that, the drop recipe changing unit 75 determines whether all drops corresponding to the non-ejecting nozzle are processed (step S37). When the all drops corresponding to the non-ejecting nozzle are not processed (step S37, No), the process returns to step S31, Alternatively, when the all drops corresponding to the non-ejecting nozzle have been processed (step S37, Yes), the process is finished.

In the above-mentioned example, the drop D1 has been relocated, but the drop D2 has not been processed. Therefore, the drop D2 is processed as described above. A position R21 is considered inappropriate as the drop relocation position, and a position R22 is selected as the drop relocation position. Instead of the drop D2, a drop D2s is located to the position R22. When the non-ejecting nozzle does not have any other drop, the drop relocation process is finished. As described above, the drop recipe is modified so that the non-ejecting nozzle does not have a drop to be dropped therefrom. In the above-mentioned example, the drop position corresponding to the non-ejecting nozzle is erased, and then the alternative position of the drop to be ejected is added. However, the embodiment is not limited to the example having been described above, and the drop position corresponding to the non-ejecting nozzle may be written on a position of a drop ejected from an ejecting nozzle.

In the first embodiment, when information about the non-ejecting nozzle is acquired after the drop recipe is generated on condition that ejection can be performed through all the nozzles 311, the relocation process of a drop corresponding to the non-ejecting nozzle is performed. Therefore, even if the non-ejecting nozzle is found, ink-jet coating can be continued without replacing the ink-jet head 31. Accordingly, it is possible to reduce the frequency of replacing the ink-jet head 31 and reduce a non-operation time of the imprinting apparatus.

Further, the drop recipe is generated at first, on condition that ejection can be performed through all the nozzles 311. Therefore, only modification of the drop corresponding to the non-ejecting nozzle is required, when the non-ejecting nozzle is found. A time required for the modification of the drop corresponding to the non-ejecting nozzle is shorter than a time required for regeneration of another drop recipe using the non-ejecting nozzle information. Therefore, it is possible to reduce the non-operation time of the apparatus.

In the above-mentioned description, the drop recipe changed when the non-ejecting nozzle is found has been described. However, the relocation of the drop may be desired as a result of the imprinting process performed by dropping the imprint agent according to the drop recipe. In such a case, the drop recipe may be changed. The change of the drop recipe is preferably performed by defining a place having the drop recipe desired to be changed, as a place of the non-ejecting nozzle.

Additionally, in the above-mentioned description, the drop recipe generation unit 72 provided in the control processor 70 has been described. However, the drop recipe generation unit 72 may not be provided in the control processor 70. When the drop recipe generation unit 72 is not provided in the control processor 70, a drop recipe externally generated may be captured to be changed in the drop recipe changing unit 75 as described above.

### Second Embodiment

In the first embodiment, first, description has been made of the generation of the drop recipe, the change of the drop position corresponding to the non-ejecting nozzle when the non-ejecting nozzle is found. In a second embodiment, description will be made of the regeneration of a whole drop recipe in consideration of a non-ejecting nozzle when the non-ejecting nozzle is found.

FIG. 8 is an exemplary block diagram illustrating a functional configuration of a control processor according to the second embodiment. A control processor 70 includes an imprinting information storage unit 71, a drop recipe generation unit 72, a nozzle ejection information acquisition unit 73, and a non-ejecting nozzle identification unit 74. Description will be omitted of the imprinting information storage unit 71, the nozzle ejection information acquisition unit 73, and the non-ejecting nozzle identification unit 74, since they have a process similar to the process having been described in the first embodiment.

The drop recipe generation unit 72 generates a drop recipe based on imprinting information and a non-ejecting nozzle, using a predetermined algorithm. That is, in the second embodiment, the drop recipe is generated at first which does not need to use the non-ejecting nozzle. The drop recipe thus generated is formed so that an RLT falls within a predetermined range relative to a target value even if the RLT is at any position on a shot area, or the drop recipe is optimized as a whole. Therefore, the drop recipe is effective when the RLT is managed strictly, for example, when a variation in RLT relative to the target value is not allowed to exceed the predetermined range. The drop recipe generation unit 72 is implemented in software.

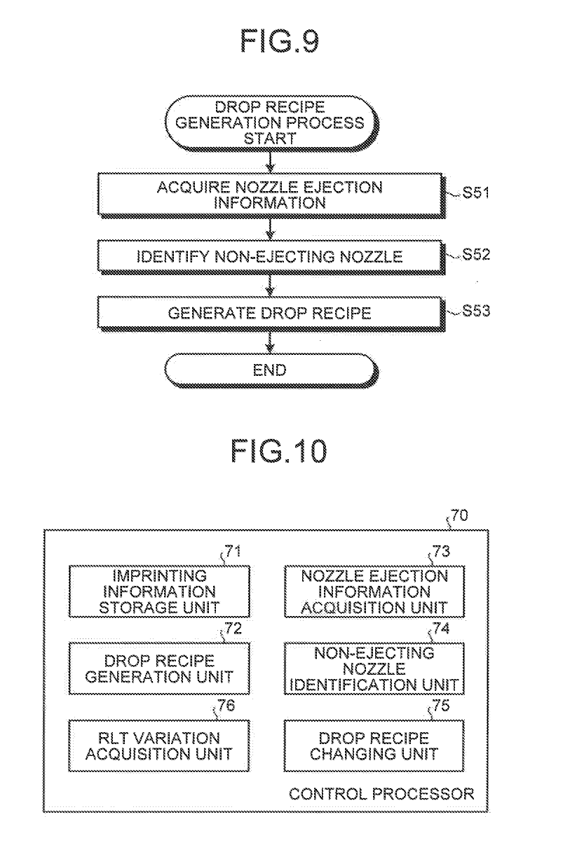

FIG. 9 is an exemplary flowchart illustrating a procedure of a drop recipe generation process according to the second embodiment. First, the nozzle ejection information acquisition unit 73 performs a test on the ink-jet head 31 mounted to the imprinting apparatus for ejection of an imprint agent, and acquires nozzle ejection information (step S51). After that, the non-ejecting nozzle identification unit 74 identifies the non-ejecting nozzle based on the nozzle ejection information (step S52).

Next, the drop recipe generation unit 72 generates the drop recipe representing an imprint agent drop position in the shot area, based on the non-ejecting nozzle, and the template information, the RLT, and the nozzle resolution in the imprinting information storage unit 71 (step S53). This is the end of the process.

In the second embodiment, before the drop recipe is generated, the non-ejecting nozzle is identified, and the drop recipe is generated based on the non-ejecting nozzle and the imprinting information. Therefore, drops in the shot area can be optimized as a whole, and the drop recipe is effective when the RLT is managed strictly. Accordingly, even if the non-ejecting nozzle is found, it is possible to generate the drop recipe in which the RLT falls within a predetermined range relative to the target value.

### Third Embodiment

FIG. 10 is an exemplary block diagram illustrating a functional configuration of a control processor according to a third embodiment. A control processor 70 includes an imprinting information storage unit 71, a drop recipe generation unit 72, a nozzle ejection information acquisition unit 73, a non-ejecting nozzle identification unit 74, a drop recipe changing unit 75, and an RLT variation acquisition unit 76. Description will be omitted of the imprinting information storage unit 71, the nozzle ejection information acquisition unit 73, the non-ejecting nozzle identification unit 74, and the drop recipe changing unit 75, since they have a process similar to the process having been described in the first embodiment.

As described in the first embodiment, the drop recipe generation unit 72 generates a first drop recipe, using imprinting information, on condition that all nozzles 311 of an ink-jet head 31 are allowed to eject an imprint agent. When the RLT variation acquisition unit 76 determines that a variation in RLT of the first drop recipe changed by the drop recipe changing unit 75 does not fall within the range of a target value, the drop recipe generation unit 72 generates a second drop recipe, using a non-ejecting nozzle and the imprinting information. The drop recipe generation. unit 72 is implemented in software.

The RLT variation acquisition unit 76 acquires the variation in RLT when an imprinting process is performed according to the first drop recipe having been changed based on the non-ejecting nozzle. The variation in RLT in a shot area may be calculated for example using the first drop recipe having been changed, or the variation in RLT may be measured based on the imprint agent having been cured by actually performing the imprinting process using the first drop recipe. The RLT variation acquisition unit 76 is implemented in software or hardware.

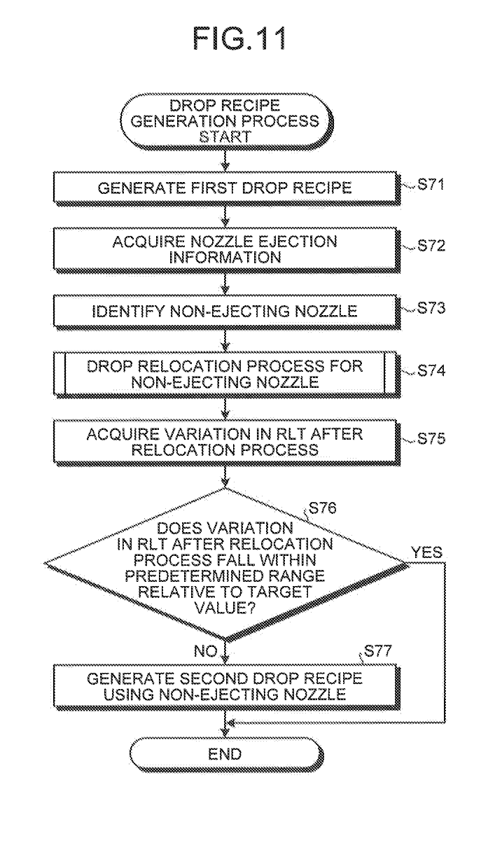

FIG. 11 is an exemplary flowchart illustrating a procedure of drop recipe generation process according to the third embodiment. First, the drop recipe generation unit 72 generates the first drop recipe representing an imprint agent drop position in the shot area, based on the template information, the RLT, and the nozzle resolution in the imprinting information storage unit 71 (step S71).

Next, the nozzle ejection information acquisition unit 73 performs a test on the ink-jet head 31 mounted to an imprinting apparatus for ejection of the imprint agent, and acquires nozzle ejection information (step S72). After that, the non-ejecting nozzle identification unit 74 identifies the non-ejecting nozzle based on the nozzle ejection information (step S73).

The drop recipe changing unit 75 performs a relocation process for relocating the drop supposed to be ejected from the non-ejecting nozzle (step S74). The relocation process is, for example, the process having been described with reference to FIG. 6 in the first embodiment.

After that, the RLT variation acquisition unit 76 acquires the variation in RLT after the relocation process (step S75). Next, the RLT variation acquisition unit 76 determines whether the variation in RLT falls within a predetermined range relative to the target value, after the relocation process (step S76).

When the variation in RLT falls within the predetermined range relative to the target value (step S76, Yes), the first drop recipe having been changed is used in subsequent imprinting process, and the process is finished.

When the variation in RLT does not fall within the predetermined range relative to the target value (step S76, No) the drop recipe generation unit 72 generates the second drop recipe, using the non-ejecting nozzle and the imprinting information (step S77). The second drop recipe is used in the imprinting process. This is the end of the process.

In the third embodiment, when the variation in RLT does not fall within the predetermined range relative to the target value by the relocation process for the drop corresponding to the non-ejecting nozzle, for the first drop recipe, the new second drop recipe is generated, using the non-ejecting nozzle and the imprinting information. On the other hand, the variation in RLT falls within the predetermined range relative to the target value in the relocation process for the first drop recipe, the first drop recipe having been changed is used for the imprinting process without generating the second drop recipe. Accordingly, it is possible to use the drop recipe according to a required variation in RLT. Further, when a requirement for variation in RLT is satisfied with the relocated first drop recipe, the second drop recipe does not need to be generated. Therefore, it is also possible to reduce a time required for generating the second drop recipe.

It is possible that the drop recipe generating method and the drop relocation method described in the present embodiments are implemented as a computer program to be executed by a computer. The computer program for causing a computer to execute the drop recipe generating method and the drop relocation method are provided in such a way that the computer program is recorded as an installable format file or executable format file in a computer-readable recording medium such as a compact disc read only memory (CD-ROM), a floppy (registered trademark) disk, and a digital versatile disc or a digital video disc (DVD). The computer program for causing a computer to execute the drop recipe generating method and the drop relocation method explained in the present embodiments can be stored in a computer connected to the network such as the Internet, and downloaded via the network.

When the drop recipe generating method and the drop relocation method are implemented as a computer program to be executed by a computer, the above described control processor 70 can be configured by an information processing apparatus such as a personal computer that includes a calculating unit such as a central processing unit (CPU), a storing unit such as a read only memory (ROM) and a random access memory (RAM), an external storing unit such a hard disk drive (HDD) and a CD-ROM drive device, a display unit such a display device, an input unit such as a keyboard and a mouse, and a network interface such as a network board if necessary. In this case, a computer program that causes a computer to execute the drop recipe generating method and the drop relocation method installed in the external storing unit is loaded on the storing unit such as a RAM and is executed by the calculating unit, thereby performing the above method.

The computer program executed by the control processor according to the present embodiments has a module configuration including the above-mentioned units (the drop recipe generation unit 72, the nozzle ejection information acquisition unit 73, the non-ejecting nozzle identification unit 74, the drop recipe changing unit 75, and the RLT variation acquisition unit 76). In an actual hardware, the CPU (a processor) reads the program from the computer-readable recording medium and executes the program. Therefore, each of the above-mentioned units is loaded on a main memory, and the drop recipe generation unit 72, the nozzle ejection information acquisition unit 73, the non-ejecting nozzle identification unit 74, the drop recipe changing unit 75, or the RLT variation acquisition unit 76 is generated in the main memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. An imprinting method of forming a pattern by ejecting an imprint agent onto a workplace from a plurality of nozzles of an ink-jet head according to a drop recipe, and putting the workplace having the imprint agent ejected thereon and a template closer to have a predetermined distance, the imprinting method comprising:
generating a first drop recipe; and
changing a drop position in the first drop recipe to another position in the vicinity of the drop position.

2. The imprinting method according to claim 1, further comprising:
identifying, after the first drop recipe is generated, a non-ejecting nozzle from among a plurality of nozzles of the ink-jet head, wherein
in the changing of the drop position, a drop position corresponding to the non-ejecting nozzle in the first drop recipe is changed to another drop position corresponding to the nozzle different from the non-ejecting nozzle.

3. The imprinting method according to claim 2, wherein, in the changing the drop position, the drop recipe is changed by erasing a first drop at a position corresponding to the non-ejecting nozzle in the drop recipe, and adding a position of a second drop to be ejected from the nozzle adjacent to the non-ejecting nozzle.

4. The imprinting method according to claim 2, wherein
the ink-jet head includes the nozzles arranged at predetermined intervals in a direction perpendicular to a scanning direction of the ink-jet head,
the first drop recipe represents the presence or absence of drops of the imprint agent at virtual grid points on a grid, the grid including a plurality of first lines extending from positions of the nozzles, in a direction perpendicular to the scanning direction, and a plurality of second lines extending in an arrangement direction of the nozzles and arranged. at predetermined intervals in the scanning direction.

5. The imprinting method according to claim 4, wherein the changing the drop position includes:
erasing a first drop being on the first line corresponding to the non-ejecting nozzle, and
arranging, additionally, a second drop at the virtual grid point adjacent to the first drop having been erased.

6. The imprinting method according to claim 5, wherein in the changing the drop position, the second drop is additionally arranged at the virtual grid point selected from the virtual grid points adjacent to the first drop having been erased, and having no another drop adjacent to the virtual grid point.

7. The imprinting method according to claim 2, wherein in the generating the first drop recipe, the first drop recipe is generated based on template information about a pattern formed on the template, nozzle resolution of the ink-jet head, and an RLT.

8. The imprinting method according to claim 7, wherein in the generating the first drop recipe, the first drop recipe is generated on condition that all the nozzles of the ink-jet head are allowed to eject the imprint agent.

9. The imprinting method according to claim 2, wherein in the identifying the non-ejecting nozzle, the non-ejecting nozzle is identified using image information obtained by imaging the imprint agent having been ejected from the nozzles of the ink-jet head.

10. The imprinting method according to claim 2, further comprising
acquiring, after the drop position is changed, a variation in RLT when an imprinting process is performed using the changed first drop recipe;
determining whether the variation in RLT falls within a predetermined range relative to the target value; and
ejecting the imprint agent from the ink-jet head according to the changed first drop recipe, when the variation in RLT falls within the predetermined range relative to the target value.

11. The imprinting method according to claim 10, further comprising:
generating a second drop recipe coating by an ejectable nozzle based on the non-ejecting nozzle, when the variation in RLT does not fall within the predetermined range relative to the target value; and
ejecting the imprint agent from the ink-jet head according to the second drop recipe.

12. An imprinting method of forming a pattern by ejecting an imprint agent onto a workpiece from a plurality of nozzles of an ink-jet head according to a drop recipe, and putting the workpiece having the imprint agent ejected thereon and a template closer to have a predetermined distance, the imprinting method comprising:
identifying a non-ejecting nozzle from among a plurality of nozzles of the ink-jet head; and
generating the drop recipe coating by an ejectable nozzle, based on the non-ejecting nozzle.

13. The imprinting method according to claim 12, wherein in the generating the drop recipe, the drop recipe is generated based on template information about a pattern formed on the template, nozzle resolution of the ink-jet head, an RLT, and the non-ejecting nozzle.

14. An imprinting apparatus comprising
a workplace holder configured to hold a workplace;
a template holder configured to hold a template, and provided to face the workplace holder;
an ink-jet head having a plurality of nozzles configured to eject an imprint agent onto the workplace; and
a control processor configured to control an operation of the ink-jet head based on a drop recipe, and to control pattern formation by putting the workpiece holder and the template holder closer to have a predetermined distance.

15. The imprinting apparatus according to claim 14, wherein the control processor is configured to
identify a non-ejecting nozzle from among a plurality of nozzles of the ink-jet head, and
generate the drop recipe coating by an ejectable nozzle, based on the non-ejecting nozzle.

16. The imprinting apparatus according to claim 15, wherein
the control processor is further configured to change the drop recipe by erasing a first drop at a position corresponding to the non-ejecting nozzle in the drop recipe, and adding a position of a second drop to be ejected from the nozzle adjacent to the non-ejecting nozzle, the drop recipe being acquired from an external device.

17. The imprinting apparatus according to claim 15, wherein the control processor is further configured to change the drop recipe by erasing a first drop at a position corresponding to the non-ejecting nozzle in the drop recipe, and adding a position of a second drop to be ejected from the nozzle adjacent to the non-ejecting nozzle, and
the control processor generates, in the generating the drop recipe, a first drop recipe on condition that all the nozzles of the ink-jet head are allowed to eject the imprint agent, and
the control processor changes, in the changing the drop recipe, the first drop recipe.

18. The imprinting apparatus according to claim 17, wherein
the control processor is further configured to acquire a variation in RLT when an imprinting process is performed using the changed first drop recipe, and determine whether the variation in RLT falls within a predetermined range relative to a target value, and
the control processor uses the changed first drop recipe for the imprinting process when the variation in RLT falls within the predetermined range relative to the target value.

19. The imprinting apparatus according to claim 18, wherein the control processor generates, in the generating the drop recipe, a second drop recipe coating by an ejectable nozzle, based on the non-ejecting nozzle when the variation in RLT does not fall within the predetermined range relative to the target value, and
the control processor uses the second drop recipe for the imprinting process.

20. The imprinting apparatus according to claim 15, wherein the control processor generates, in the generating the drop recipe, the drop recipe based on template information about a pattern formed on the template, nozzle resolution of the ink-jet head, and an RLT.
